(19) United States
(12) Patent Application Publication
(10) Pub. No.: US 2007/0073955 A1
(43) Pub. Date: Mar. 29, 2007

(54) Multi-function PCI device

(76) Inventors: Joseph Murray, Scottsdale, AZ (US); Sailesh Bissessur, Phoenix, AZ (US); Shailendra Jha, Folsom, CA (US); Victor Lau, Marlboro, MA (US); Bruno DiPlacido, Westborough, MA (US); Nai-Chih Chang, Shrewsbury, MA (US); Suresh Chemudupati, Marlboro, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/239,741

(22) Filed: Sep. 29, 2005

(51) Int. Cl. G06F 13/36

(52) U.S. Cl. 710/309

(57) ABSTRACT

A multi-function peripheral component interconnect (PCI) device is disclosed. The device includes a first configuration data structure associated with a first PCI function, a second configuration data structure associated with a second PCI function and a PCI bridge, coupled the first and second configuration data structures. The PCI bridge processes transactions on behalf of the first and second functions.

### FIELD OF THE INVENTION

The present invention relates to computer systems; more particularly, the present invention relates to peripheral component interconnect (PCI) devices.

### BACKGROUND

PCI devices feature an interconnection between various attached devices and a microprocessor in which expansion slots are spaced closely for high speed operation. Currently, multi-function PCI devices are being implemented, which allow a particular device to abstract multiple functions in PCI, PCI extended (PCI-X) or PCI-Express. However, in such devices an application bridge is included for each implemented function. Therefore, transaction and physical layers are replicated for each function, resulting in increased overhead to interface multi-function devices.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates a conventional multi-function device;

FIG. 3 illustrates one embodiment of a multi-function device;

FIG. 4 illustrates another embodiment of a multi-function device; and

FIG. 5 illustrates one embodiment of a common application bridge.

### DETAILED DESCRIPTION

A multi-function PCI device having a common bridge is described. In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

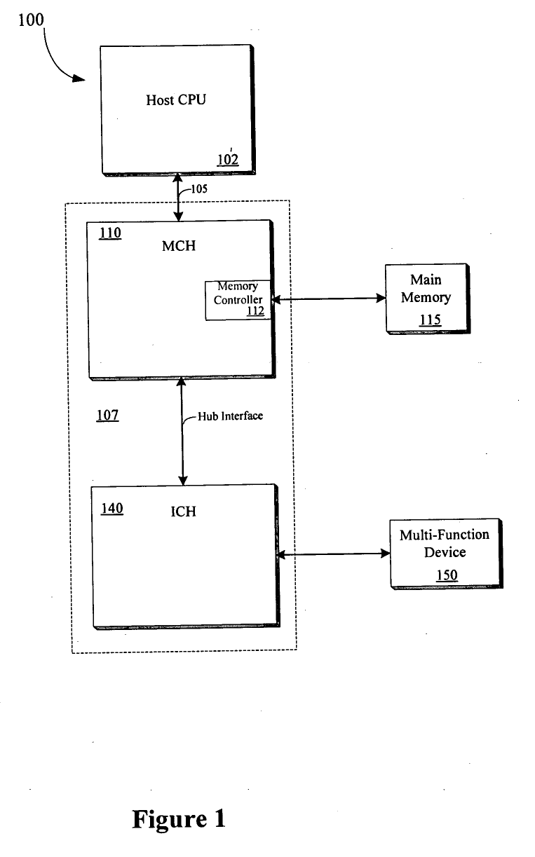

FIG. 1 is a block diagram of one embodiment of a computer system 100. Computer system 100 includes a central processing unit (CPU) 102 coupled to an interface 105. In one embodiment, CPU 102 is a processor in the Pentium® family of processors Pentium® IV processors available from Intel Corporation of Santa Clara, Calif. Alternatively, other CPUs may be used.

For instance, CPU 102 may be implemented using multiple processing cores. In other embodiments, computer system 100 may include multiple CPUs 102

In a further embodiment, a chipset 107 is also coupled to interface 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to interface 105, such as multiple CPUs and/or multiple system memories.

MCH 110 is coupled to an input/output control hub (ICH) 140 via a hub interface. ICH 140 provides an interface to input/output (I/O) devices within computer system 100. ICH 140 may support standard I/O operations on I/O busses such as peripheral component interconnect (PCI), accelerated graphics port (AGP), universal serial bus (USB), low pin count (LPC) bus, or any other kind of I/O bus (not shown).

According to one embodiment, a multi-function PCI device 150 is coupled to ICH 140. In a further embodiment, device 150 may be a storage controller. However in other embodiments, other multi-function applications (e.g., network interface controller) may be implemented at device 150.

Traditionally, multi-function PCI devices employ a configuration data structure (Configuration header) per function, which allows computer system 100 to identify and control a device associated with the function. In addition, each function includes transaction queues to transport requests to and from the function. In a complex multi-function device many PCI interfaces may be required.

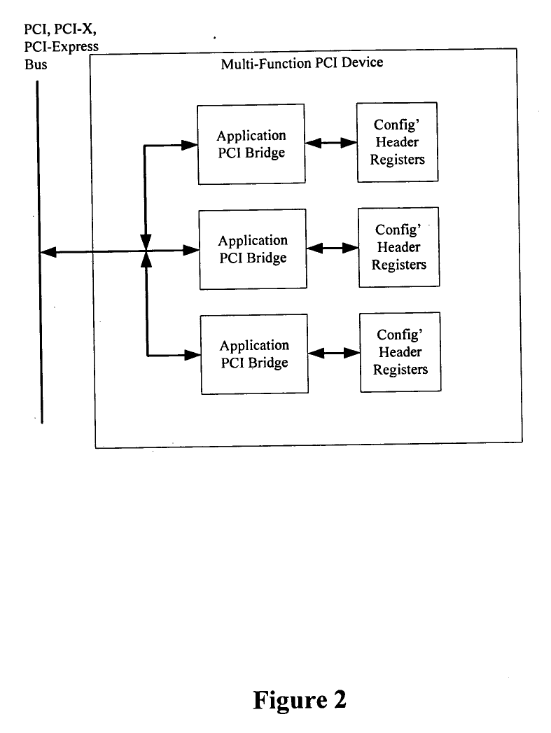

FIG. 2 illustrates a conventional multi-function device. As shown in FIG. 2, an application PCI bridge is coupled between a multi-function (e.g., PCI, PCI-X, and PCI-Express) bus and a register associated with the Configuration header for each function. As discussed above, transaction and physical layers are replicated for each function, leading to increased overhead to interface multi-function devices.

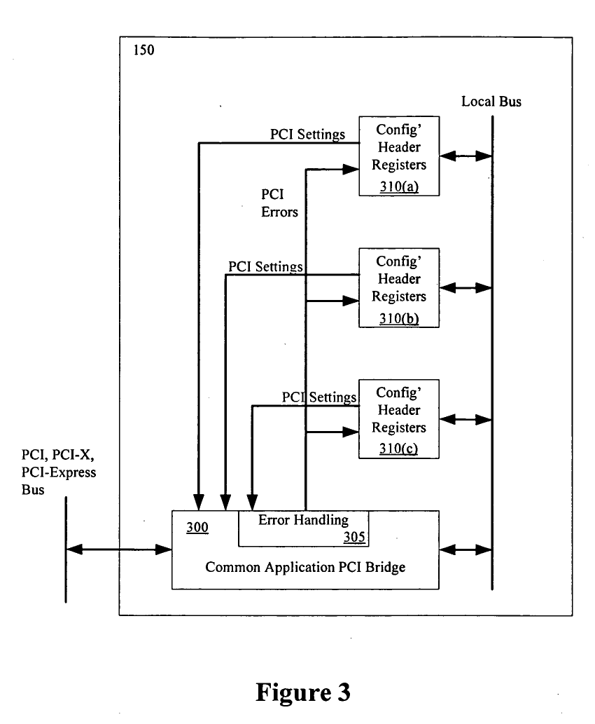

According to one embodiment, a single application PCI bridge is provided behind which multiple functions in PCI, PCI-X or PCI-Express may be implemented. FIG. 3 illustrates one embodiment of a multi-function device 150. Multi-function device 150 includes a common application PCI bridge 300 with multiple Configuration header registers 310(a)-310(c) behind bridge 300, each representing a different function. The common bridge 300 processes transactions on behalf of all functions.

According to one embodiment, bridge 300 is coupled to the Configuration headers of each function via separate sideband signal interfaces. Consequently, bridge 300 receives the “settings” for each function (e.g., Base-Address-Registers (or BARS)) via the sideband signals. In a further embodiment, bridge 300 processes each transaction based upon the current settings of the associated function.

Although illustrated as supporting three functions in FIG. 3, bridge 300 may support any number of functions up to the maximum supported in PCI (e.g., 8). In other embodiments, bridge 300 may also support multiple devices up to the maximum supported in PCI (e.g., 32). In such an embodiment, bridge 300 could support as many as 256 (or 32×8) functions.

According to one embodiment, for transactions to the configuration headers 310 the PCI address is translated to a local bus address. Similarly, there is some address space on the local bus that is allocated to PCI configuration header 310 space. Therefore, the PCI configuration header blocks 310 are local bus targets which decode their respective address spaces.

In a further embodiment, bridge 300 uses a function's BARS (not-shown) to claim PCI transactions on behalf of the function in order to translate to a local bus address and forward to a memory controller on the local bus. In yet a further embodiment, local bus initiators (e.g. DMA or CPU) may initiate outbound (local to PCI) transactions on behalf of any function. As a result, each PCI function includes an abstract collection of initiators and targets on the local bus.

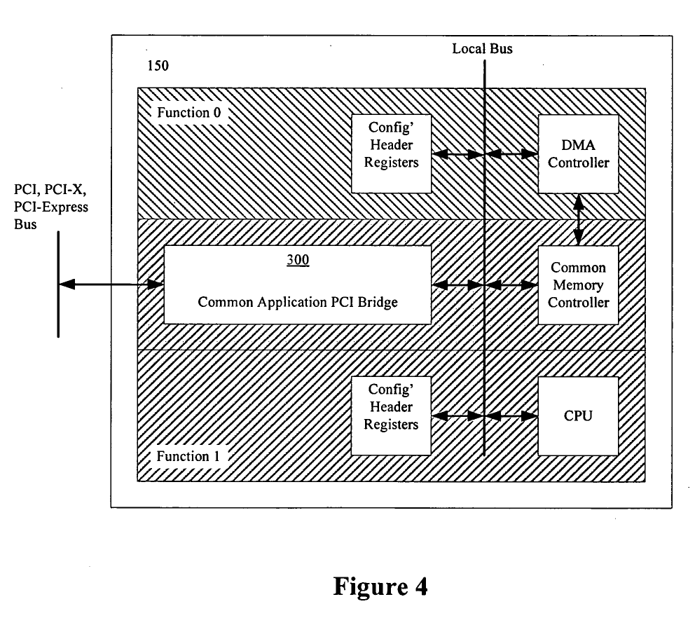

FIG. 4 is a more detailed embodiment illustrating how device 300 assembles initiators and targets. In this embodiment, device 300 is a two function device, where a Function 0 incorporates Configuration header, Memory Controller and DMA Controller and a Function 1 incorporates Configuration header, Memory Controller and CPU. Not that in other embodiments, multiple DMA controllers, multiple CPUs, and multiple memory controllers may be included within device 300.

According to one embodiment, device 300 is programmable to enable the DMA controllers, CPUs, and memory controllers to be assembled into a variety of functions configuration of the. Consequently, the multi-function device 150 can take on different characteristics by enabling or disabling various function headers, and/or remapping the inbound translation functions to different targets on the local bus.

Referring to FIG. 4, PCI transactions received at the BAR of Function 0 may be claimed by the bridge and translated to an address that will hit region A of the memory controller, while PCI transactions received at the BAR of Function 1 can be translated to an address that will hit region B of the memory controller (or even a different memory controller).

Local bus transactions originated by the CPU or by the DMA controller may be claimed by bridge 300 and originated on the PCI bus using the appropriate function number. As discussed above, the translations are fully programmable, enabling bridge 300 to implement PCI functions as an abstract collection of features.

Referring back to FIG. 3, bridge 300 also includes error handling logic 305 to detect PCI errors (e.g. master-Abort, etc.). In addition, logic 305 reports errors to each function via a common error reporting bus. According to one embodiment, each error is tagged with an identifier corresponding to the function for which the error occurred and is subsequently transmitted on the error reporting bus.

For instance, an error associated with a function corresponding to Configuration header register 310(a) is appropriately tagged and transmitted on the error reporting bus. Consequently, Configuration header register 310(a) recognizes the tag and captures the error based upon the function identifier and logs the error.

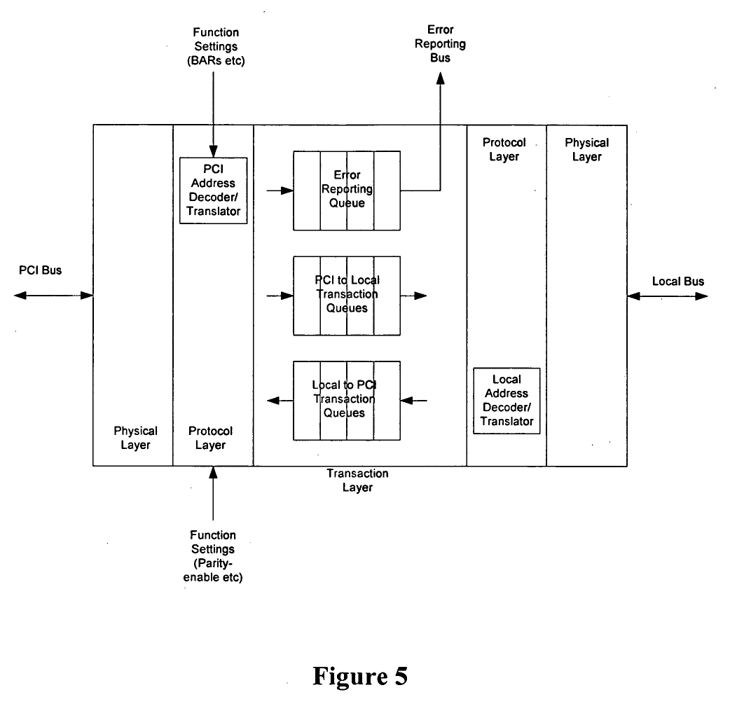

FIG. 5 illustrates one embodiment of a more detailed view of a bridge 300. As shown in FIG. 5, bridge 300 is coupled between the local bus and the PCI bus by physical layers. In addition, each physical layer is associated with a protocol layer having translation decoders to perform PCI/local and local/PCI translations. A transaction layer is included between the protocol layers. The transaction layer includes PCI/local and local/PCI to temporarily store the corresponding transactions prior to the above-described translations. In addition, an error reporting queue is included to support error handling logic 305 by temporarily storing PCI error reports.

The above-described multi-function PCI device significantly reduces the overhead to interface multi-function devices to PCI by sharing the transaction and physical layers.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A multi-function peripheral component interconnect (PCI) device comprising:
a first configuration data structure associated with a first PCI function;
a second configuration data structure associated with a second PCI function; and
a PCI bridge, coupled to the first and second configuration data structures, to process transactions on behalf of the first and second functions.

2. The device of claim 1 further comprising:
a first side band interface coupled between the bridge and the first configuration data structure; and
a second side band interface coupled between the bridge and the second configuration data structure.

3. The device of claim 2 wherein the bridge receives settings for the first and second functions via sideband signals received via the first and second side band interfaces.

4. The device of claim 3 wherein the bridge processes transactions based upon current settings for the first and second functions.

5. The device of claim 1 further comprising error handling logic to detect PCI errors received at the bridge.

6. The device of claim 5 further comprising an error reporting bus coupled to the error handling logic and the first and second configuration data structures.

7. The device of claim 6 wherein the error handling logic reports errors to the first and second functions by tagging each error with an identifier associated with the particular function and transmitting the error on to the error reporting bus.

8. A method comprising:
receiving a first transaction at a peripheral component interconnect (PCI) bridge;
determining whether the first transaction is associated with a first PCI function or associated with a second PCI function; and
transmitting the first transaction to a first configuration data structure if the first transaction is associated with the first PCI function.

9. The method of claim 8 further comprising transmitting the first transaction to a second configuration data structure if the second transaction is associated with the second PCI function.

10. The method of claim 8 further comprising:
detecting an error in the first transaction at the bridge after determining that the first transaction is associated with the first PCI function; and
tagging the error with an identifier associated with the first PCI function; and
transmitting the error on to an error reporting bus.

11. The method of claim 8 further comprising:
receiving settings at the bridge for the first function via a first sideband interface; and
receiving settings at the bridge for the second function via a second sideband interface.

12. A system comprising:
a central processing unit (CPU);
a control hub coupled to the CPU; and
a multi-function device, coupled to the control hub, having:
a first configuration data structure associated with a first PCI function;
a second configuration data structure associated with a second PCI function; and
a PCI bridge, coupled the first and second configuration data structures, to process transactions on behalf of the first and second functions.

13. The system of claim 12 wherein the device further comprises:
a first side band interface coupled between the bridge and the first configuration data structure; and
a second side band interface coupled between the bridge and the second configuration data structure.

14. The system of claim 13 wherein the bridge receives settings for the first and second functions via sideband signals received via the first and second side band interfaces.

15. The system of claim 14 wherein the bridge processes transactions based upon current settings for the first and second functions.

16. The system of claim 12 further comprising error handling logic to detect PCI errors received at the bridge.

17. The system of claim 16 further comprising an error reporting bus coupled to the error handling logic and the first and second configuration data structures.

18. The system of claim 17 wherein the error handling logic reports errors to the first and second functions by tagging each error with an identifier associated with the particular function and transmitting the error on to the error reporting bus.

19. The system of claim 12 wherein the device is a network interface controller.

20. The system of claim 12 wherein the device is a storage controller.
